(19) United States
(12) Patent Application Publication
(10) Pub. No.: US 2010/0134245 A1
(43) Pub. Date: Jun. 3, 2010

(54) SYSTEM AND METHOD FOR AUTHENTICATING A MEETING

(75) Inventors: Florian Klinger, Yavne (IL); Youval Rasin, Tel-Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: BIO-GUARD COMPONENTS AND TECHNOLOGIES LTD., Rosh Ha'Ain (IL)

(21) Appl. No.: 12/282,881

(22) PCT Filed: Mar. 7, 2007
(86) PCT No.: PCT/IL07/00293

§ 371 Date: Feb. 11, 2009

Related U.S. Application Data
(60) Provisional application No. 60/782,455, filed on Mar. 14, 2006.

(51) Int. Cl. G06F 7/04

(52) U.S. Cl. 340/5.82

(57) ABSTRACT

A method for authenticating a meeting, including obtaining biometric information belonging to each of at least two participants in the meeting within a predetermined time duration, using said biometric information of the at least two participants to authenticate identities of the at least two participants, providing a meeting authentication message to the at least two participants, and storing the biometric information and the meeting authentication message in a database.

### SUMMARY OF THE INVENTION

The present invention seeks to provide a system and a method for authenticating a meeting between people.

There is thus provided in accordance with a preferred embodiment of the present invention a method for authenticating a meeting, including obtaining biometric information belonging to each of at least two participants in the meeting within a predetermined time duration, using the biometric information of the at least two participants to authenticate identities of the at least two participants, providing a meeting authentication message to the at least two participants and storing the biometric information and the meeting authentication message in a database.

In accordance with a preferred embodiment of the present invention the authentication message includes identifiers of the participants, the date of the meeting, the time of the meeting and the location of the meeting. Preferably, the obtaining biometric information belonging to each of at least two participants includes obtaining, for each of the at least two participants, at least one of fingerprint information; handprint information; irises information; eye retina information; a voice pattern; and a facial pattern.

In accordance with another preferred embodiment of the present invention the obtaining biometric information belonging to each of at least two participants includes obtaining the biometric information belonging to each of the at least two participants simultaneously. Preferably, the obtaining biometric information belonging to each of at least two participants includes obtaining the biometric information belonging to at least one of the at least two participants from a biometric smart card.

There is also provided in accordance with a further preferred embodiment of the present invention a system for authenticating a meeting, including a biometric data reader for obtaining biometric information belonging to each of at least two participants in the meeting within a predetermined time duration, at least one server for authenticating identities of the at least two participants using the biometric information belonging to the at least two participants and for providing a meeting authentication message to the at least two participants and a database for storing the biometric information belonging to the at least two participants and the meeting authentication message.

In accordance with a preferred embodiment of the present invention the authentication message includes identifiers of the participants, the date of the meeting, the time of the meeting and the location of the meeting. Preferably, the biometric information belonging to each of the at least two participants includes at least one of fingerprint information; handprint information; irises information; eye retina information; a voice pattern; and a facial pattern.

In accordance with another preferred embodiment of the present invention the biometric data reader is operative to obtain the biometric information belonging to each of the at least two participants in the meeting simultaneously. Preferably, the biometric data reader is operative to obtain the biometric information belonging to at least one of the at least two participants from a biometric smart card.

### BRIEF DESCRIPTION OF THE DRAWINGS

The present invention will be understood and appreciated more fully from the following detailed description, taken in conjunction with the drawings in which:

FIG. 1 is a simplified illustration of meeting authentication functionality operative in accordance with a preferred embodiment of the present invention; and

FIG. 2 is a simplified illustration of meeting authentication functionality operative in accordance with another preferred embodiment of the present invention.

### DETAILED DESCRIPTION OF PREFERRED EMBODIMENTS

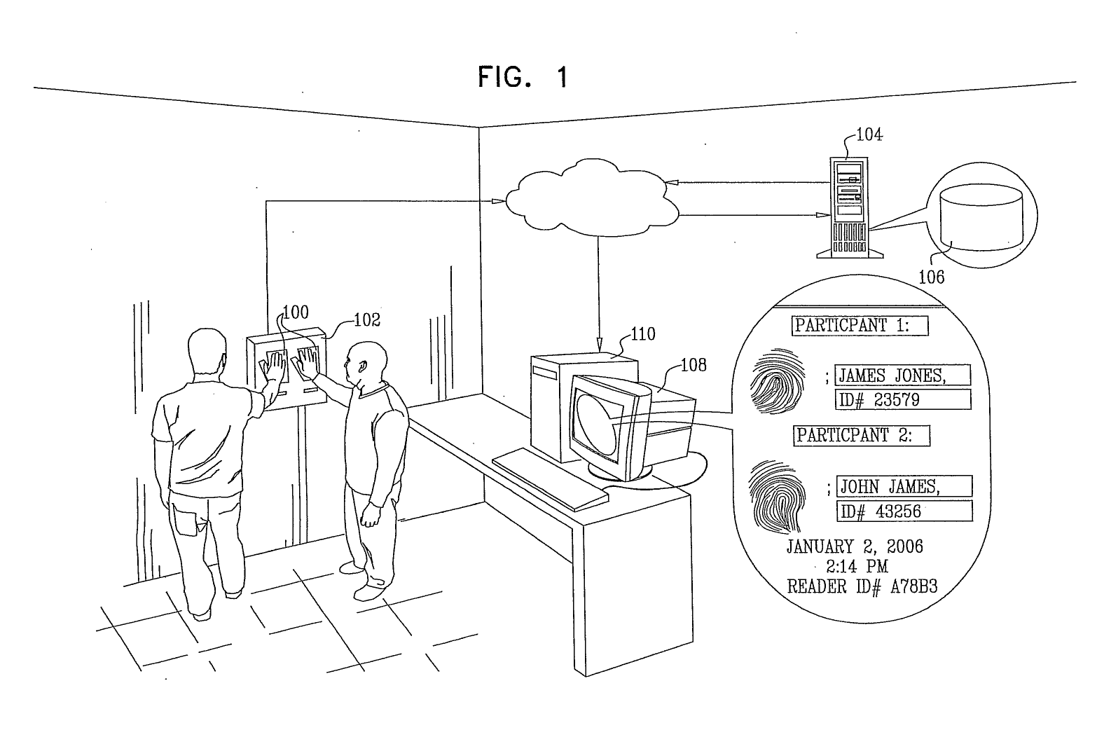

Reference is now made to FIG. 1, which is a simplified illustration of meeting authentication functionality operative in accordance with a preferred embodiment of the present invention.

As seen in FIG. 1, each of a plurality of participants in a meeting, here shown as two participants, simultaneously provides biometric data such as fingerprints or handprints to one or more data-obtaining windows 100 of a biometric data reader 102, here shown as a handprint reader. Alternatively, the biometric data reader 102 may be adapted to receive any type of biometric data including eye retinas and irises, voice patterns and facial patterns. As a further alternative, the participants in the meeting may provide the biometric data to the biometric data reader 102 within a predetermined time period.

The biometric data obtained by reader 102 is preferably transferred via a network, typically the Internet, to a trustee server 104, which preferably communicates with a biometric data database 106. The biometric data received by trustee server 104 is compared with the data stored in database 106 in order to authenticate the identities of the participants and to obtain additional information about the participants in the meeting. The additional information may include any of participant name, participant identification number, participant address and any other suitable participant information.

Once the information related to the participants is found in the database 106 and the identity of the participants is authenticated, a meeting authentication message including the biometric data, participant information, date, time and meeting location is displayed to the participants in the meeting, typically on a display 108 of a computer 110 which communicates via a network such as the internet with trustee server 104. The computer 110 preferably communicates via a network, such as for example, a wireless network with biometric data reader 102 and provides the meeting authentication message thereto. Preferably, the meeting authentication message and the biometric data of the participants as obtained by reader 102 are also stored in database 106, such that database 106 contains information relating to all authenticated meetings.

Preferably, the meeting location is indicated by indicating the specific biometric data reader at which the biometric data was received, such as by indicating a biometric data reader identification number.

It is appreciated that a meeting authenticated in accordance with the method of the present invention may be re-authenticated at any time following the meeting, by accessing the meeting authentication message and information stored in database 104.

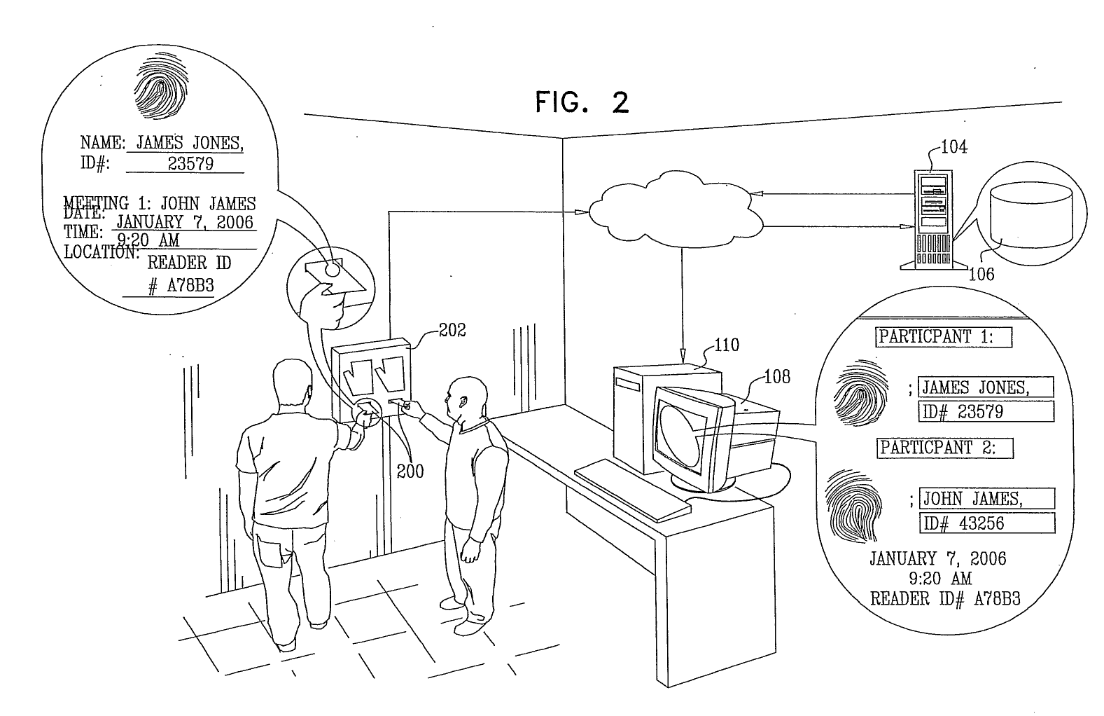

Reference is now made to FIG. 2, which is a simplified illustration of meeting authentication functionality operative in accordance with another preferred embodiment of the present invention:

As seen in FIG. 2, each of a plurality of participants in a meeting, here shown as two participants, simultaneously provides biometric data via a biometric data-containing smart card 200 to a biometric data reader 202, here shown as a smart card reader. The biometric data provided to reader 202 from each smart card 200 may include data related to the participant's fingerprints, handprints, eye retinas and irises, voice patterns and facial patterns. Alternatively, the participants in the meeting may provide the biometric data to the biometric data reader 202 within a predetermined time period.

The biometric data obtained by reader 202 is preferably transferred via a network, typically the Internet, to a trustee server 204, which preferably communicates with a biometric data database 206. The biometric data received by trustee server 204 is compared with the data stored in database 206 in order to authenticate the identities of the participants and to obtain additional information about the participants in the meeting. The additional information may include any of participant name, participant identification number, participant address and any other suitable participant information.

Once the information related to the participants is found in the database 206 and the identity of the participants is authenticated, a meeting authentication message including the biometric data, participant information, date, time and meeting location is displayed to the participants in the meeting, typically on a display 208 of a computer 210 which communicates via a network such as the internet with trustee server 204. The computer 210 preferably communicates via a network, such as for example, a wireless network, with biometric data reader 202 and provides the meeting authentication message thereto. Preferably, the meeting authentication message and the biometric data of the participants as obtained by reader 202 are also stored in database 206, such that database 206 contains information relating to all authenticated meetings. Additionally, the meeting authentication message is preferably stored on the smart card 200 of each of the participants in the meeting, such that the smart card 200 of each participant contains a listing of all authenticated meetings that the card owner participated in.

Preferably, the meeting location is indicated by indicating the specific biometric data reader at which the biometric data was received, such as by indicating a biometric data reader identification number.

It is appreciated that a meeting authenticated in accordance with the method of the present invention may be re-authenticated at any time following the meeting, by accessing the meeting authentication message and information stored in database 204. Alternatively, the meeting authentication message may be accessed by retrieving this information from at least one of the smart cards 200 of the participants in the meeting.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A method for authenticating a meeting, comprising:
obtaining biometric information belonging to each of at least two participants in said meeting within a predetermined time duration;
using said biometric information of said at least two participants to authenticate identities of said at least two participants;
providing a meeting authentication message to said at least two participants; and
storing said biometric information and said meeting authentication message in a database.

2. A method for authenticating a meeting according to claim 1, and wherein said authentication message includes identifiers of said participants, the date of said meeting, the time of said meeting and the location of said meeting.

3. A method for authenticating a meeting according to claim 1 and wherein said obtaining biometric information belonging to each of at least two participants comprises obtaining, for each of said at least two participants, at least one of:
fingerprint information;
handprint information;
irises information;
eye retina information;
a voice pattern; and
a facial pattern.

4. A method for authenticating a meeting according to claim 1 and wherein said obtaining biometric information belonging to each of at least two participants comprises obtaining said biometric information belonging to each of said at least two participants simultaneously.

5. A method for authenticating a meeting according to claim 1 and wherein said obtaining biometric information belonging to each of at least two participants comprises obtaining said biometric information belonging to at least one of said at least two participants from a biometric smart card.

6. A system for authenticating a meeting, comprising:
a biometric data reader for obtaining biometric information belonging to each of at least two participants in said meeting within a predetermined time duration;
at least one server for authenticating identities of said at least two participants using said biometric information belonging to said at least two participants and for providing a meeting authentication message to said at least two participants; and
a database for storing said biometric information belonging to said at least two participants and said meeting authentication message.

7. A system for authenticating a meeting according to claim 6, and wherein said authentication message includes identifiers of said participants, the date of said meeting, the time of said meeting and the location of said meeting.

8. A system for authenticating a meeting according to claim 6 and wherein said biometric information belonging to each of said at least two participants includes at least one of:
fingerprint information;
handprint information;
irises information;
eye retina information;
a voice pattern; and
a facial pattern.

9. A system for authenticating a meeting according to claim 6 and wherein said biometric data reader is operative to obtain said biometric information belonging to each of said at least two participants in said meeting simultaneously.

10. A system for authenticating a meeting according to claim 6 and wherein said biometric data reader is operative to obtain said biometric information belonging to at least one of said at least two participants from a biometric smart card.
